(19) United States
(12) Patent Application Publication
(10) Pub. No.: US 2025/0007906 A1
(43) Pub. Date: Jan. 2, 2025

(54) COMMUNICATION SYSTEM AND INFORMATION PROCESSING APPARATUS

(71) Applicant: CANON KABUSHIKI KAISHA, Tokyo (JP)

(72) Inventor: ANNA HOSAKA, Ibaraki (JP)

(21) Appl. No.: 18/753,615

(22) Filed: Jun. 25, 2024

(30) Foreign Application Priority Data
Jun. 28, 2023 (JP) 2023-105933

(51) Int. Cl. H04L 9/40

(52) U.S. Cl. CPC H04L 63/083

(57) ABSTRACT

A communication system includes an image generation server configured to performs rendering of web contents and an information processing apparatus configured to execute a first application to be managed with first management information and acquire the web contents related to a result of the rendering includes one or more controllers including one or more processors and one or more memories, the one or more controllers being configured to create a second application to be managed with second management information different from the first management information and acquire web contents based on the result of the rendering, and set authentication information to the second application.

### BACKGROUND

### Field

The present disclosure relates to a communication system and an information processing apparatus.

### Description of the Related Art

There are widely available communication terminals that include a web browser (hereinafter, called browser) and have the function of viewing web pages on the browser. Displaying web pages of an external service through the browser allows a communication terminal to cooperate with the external service.

The external service may include private information and require user authentication in order to protect the private information. However, the browser has the function of saving user authentication information. Using the function allows a user to pass the user authentication of the external service using the saved user authentication information and access the external service.

Japanese Patent Application Laid-Open No. 2004-122778 discusses function-based authentication by which a user is identified by user management and the user's use of each application is enabled or restricted. At the function-based authentication, the menu of application selections is displayed at the time of startup of the image formation device. The user authentication is required only if the application selected by the user is not available for all users. For example, Japanese Patent Application Laid-Open No. 2004-122778 discusses a technology by which a copying application is made available to all users, whereas a scanning and transmitting application is made available to only users who have passed the user authentication.

However, one image formation device may be operated by a plurality of users. If the web browser in the image formation device operated by a plurality of users saves authentication information for accessing an external service, an unauthorized user may be able to access the external service.

### SUMMARY

In view of the above issue, the present disclosure is directed to easily implementing user authentication in accessing an external service at an image formation device.

According to an aspect of the present disclosure, a communication system includes an image generation server configured to perform rendering of web contents and an information processing apparatus configured to execute a first application to be managed with first management information and acquire the web contents related to a result of the rendering includes one or more controllers including one or more processors and one or more memories, the one or more controllers being configured to create a second application to be managed with second management information different from the first management information and acquire web contents based on the result of the rendering, and set authentication information to the second application.

Further features of the present disclosure will become apparent from the following description of exemplary embodiments with reference to the attached drawings.

### BRIEF DESCRIPTION OF THE DRAWINGS

FIG. 1 is a block diagram illustrating a hardware configuration example of an image formation device.

FIG. 2 is a block diagram illustrating a software configuration example of the image formation device.

FIGS. 3A to 3D are diagrams illustrating examples of display screens on the image formation device.

FIG. 4 is a diagram illustrating an example of an application settings screen.

FIG. 5 is a diagram illustrating an example of a flowchart of processing performed by an application.

FIGS. 6A and 6B are each a diagram illustrating an example of a flowchart of processing performed by a shortcut.

FIGS. 7A and 7B are diagrams illustrating examples of setting information held by shortcuts.

FIG. 8 is a diagram illustrating an example of a sequence of processing for creating a shortcut.

FIG. 9 is a diagram illustrating an example of a sequence of processing for executing a shortcut.

FIG. 10 is a diagram illustrating an example of a sequence of processing after startup of an application.

FIG. 11 is a diagram illustrating an example of a communication system.

### DESCRIPTION OF THE EMBODIMENTS

Exemplary embodiments of the present disclosure will be described in detail with reference to the drawings. The following exemplary embodiments are not intended to limit the disclosure according to the claims. In addition, not all of combinations of features in the exemplary embodiments are used in the solution provided by the disclosure. In the exemplary embodiments, an image formation device will be taken as an example of an information processing apparatus, but the present disclosure is not limited to this example.

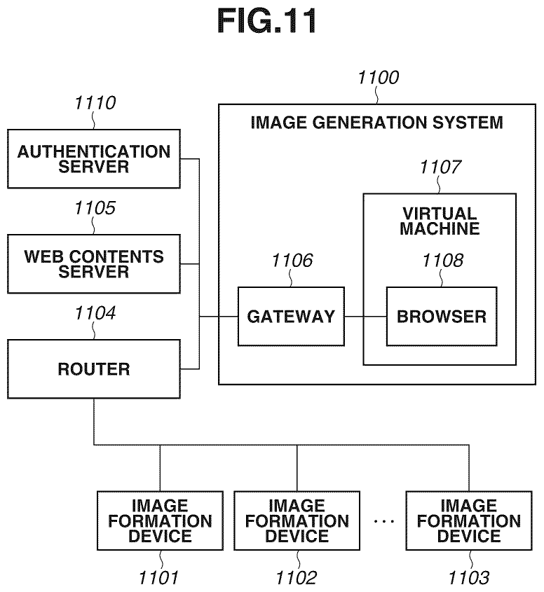

FIG. 11 is a diagram illustrating an example of an overall configuration of a communication system according to an exemplary embodiment of the present disclosure.

In the system illustrated in FIG. 11, while the user looks at the screen of an image formation device 1101, the user operates the image formation device 1101 to input the URL of a web contents server 1105 that contains web contents the user wishes to browse. Upon receipt of the input, the image formation device 1101 transmits the URL of the web contents server 1105 through a router 1104 to an image generation system 1100 that is a cloud-based information processing system.

The image formation device 1101 has the function of printing an image or the function of transmitting image data generated by scanning to a destination. FIG. 11 illustrates an example in which three image formation devices are connected, but an arbitrary number of connections can be made. The image formation device 1101, an image formation device 1102, and an image formation device 1103 are identical in configuration, and hereinafter, the image formation device 1101 alone will be described.

A browser 1108 in a virtual machine 1107 of the image generation system 1100 receives the URL of the web contents server 1105 transmitted by the image formation device 1101 via a gateway 1106. Then, the browser 1108 accesses the web contents server 1105 corresponding to the received URL via the gateway 1106. The web contents server 1105 generates web contents of the requested URL and transmits the web contents to the browser 1108 that is a requester. The image generation system is constructed with an image generation server.

An authentication server 1110 is a server that performs an authentication process when the image formation device 1101 accesses the web contents server 1105. The authentication server 1110 is specifically an example of an authentication site, such as OAuth.

The browser 1108 generates results of rendering the web contents received from the web contents server 1105. The browser 1108 then transmits the generated results of rendering the web contents to the image formation device 1101 via the gateway 1106. The image formation device 1101 receives the results of rendering the web contents transmitted by the image generation system 1100, and provides the web contents to the user by displaying the received rendering results.

In the system of the cloud web browser, besides the image formation device 1101, a plurality of image formation devices may be connected, such as the image formation devices 1102 and 1103.

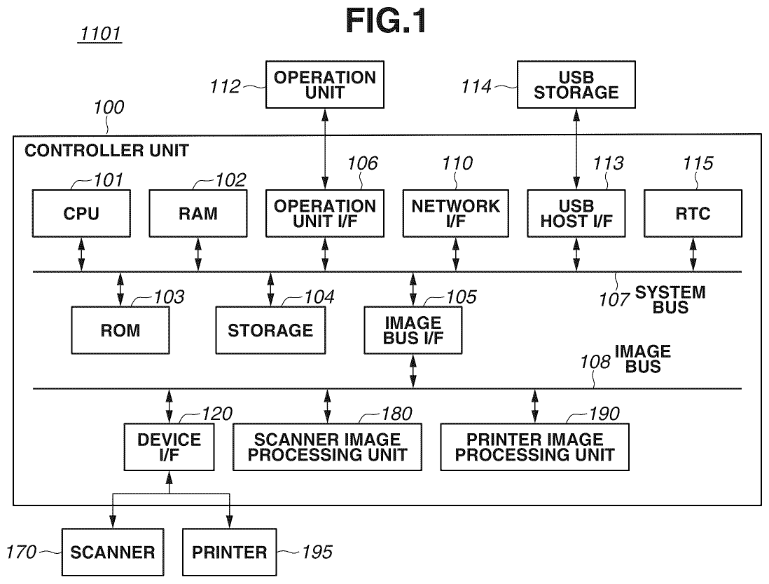

FIG. 1 is a diagram illustrating a hardware configuration of the image formation device 1101 according to the present exemplary embodiment of the present disclosure. In the present exemplary embodiment, the image formation device 1101 will be described as an example. The image formation device 1101 includes a controller unit 100. The controller unit 100 is connected to a scanner 170 that is an image input device, a printer 195 that is an image output device, and an operation unit 112. The controller unit 100 performs control to carry out the copying function of reading a document by the scanner 170 and printing the generated image data on a sheet by the printer 195.

The controller unit 100 includes a central processing unit (CPU) 101. The CPU 101 boots an operation system (OS) with a boot program stored in a read only memory (ROM) 103. The CPU 101 runs programs stored in a storage 104 on the OS to carry out various processes. As a working area for the CPU 101, a random access memory (RAM) 102 is used. The RAM 102 provides the working storage and an image memory storage for temporarily storing image data. The storage 104 stores programs and image data.

The CPU 101 is connected to the ROM 103, the RAM 102, and an operation unit interface (I/F) 106 through a system bus 107. The CPU 101 is also connected to a network I/F 110, a universal serial bus (USB) host I/F 113, and an image bus I/F 105. The operation unit I/F 106 is an interface with the operation unit 112 including a touch panel, and outputs image data to be displayed on the operation unit 112 to the operation unit 112. The operation unit I/F 106 sends information input by the user through the operation unit 112 to the CPU 101. The network I/F 110 is an interface for connecting the image formation device 1101 to a local area network (LAN).

The USB host I/F 113 is an interface unit that communicates with the USB storage 114. The USB host I/F 113 is an output unit for storing the data in the storage 104, into the USB storage 114. The USB host I/F 113 inputs the data stored in the USB storage 114 and transfers the data to the CPU 101. The USB storage 114 is an external storage device that stores data and is detachably attached to the USB host I/F 113. The USB host I/F 113 is connectable to a plurality of USB devices including the USB storage 114.

A real time clock (RTC) 115 controls the current time. Time information controlled by the RTC 115 is used for recording a job input time and other information.

The image bus I/F 105 is a bus bridge that connects the system bus 107 and an image bus 108 for transferring image data at a high speed and converting the data format. On the image bus 108, a device I/F 120, a scanner image processing unit 180, and a printer image processing unit 190 are provided. The device I/F 120 is connected to the scanner 170 and the printer 195. The device I/F 120 performs synchronous/asynchronous conversion of image data. The scanner image processing unit 180 corrects, processes, and edits input image data. The printer image processing unit 190 performs correction, resolution conversion, and other processing on the print output image data for the printer 195.

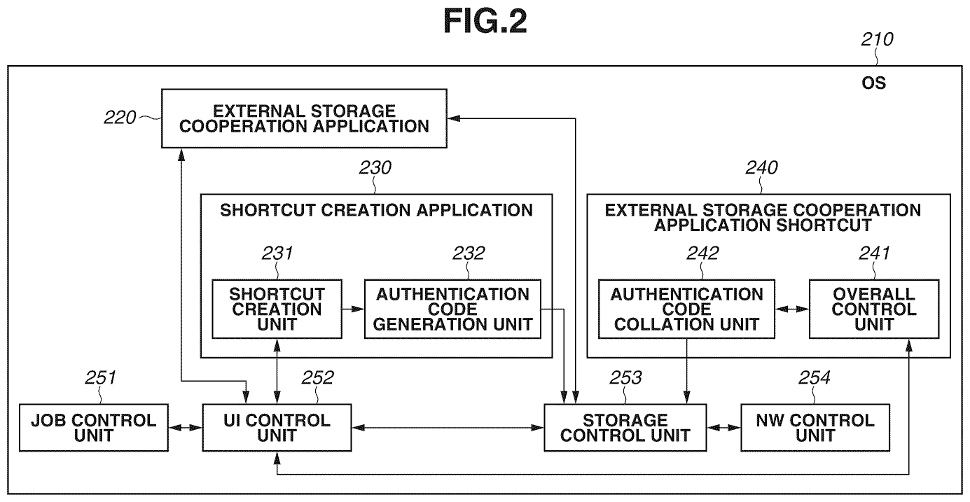

FIG. 2 is a diagram illustrating a software configuration of the image formation device 1101 according to the present exemplary embodiment of the present disclosure. The units indicated by solid lines in FIG. 2 are software modules that are implemented by the CPU 101 running main programs loaded into the RAM 102. The main programs manage and control the execution of the modules described below by an OS 210.

A user interface (UI) control unit 252 displays a screen on the operation unit 112 and receives an operation by the user through the operation unit I/F 106. The UI control unit 252 also has the function of making a notification to another module and controlling screen update in response to a rendering instruction from the other module.

A job control unit 251 is a module that controls job processes, such as copying, scanning, and printing, in response to job execution instructions from the UI control unit 252. A network (NW) control unit 254 controls the network I/F 110 and controls communication with an external device in response to a communication request from another module. The NW control unit 254 also receives a notification from an external device and transfers the notification to another module.

A storage control unit 253 manages the setting information and job information recorded in the storage 104. Each module located in the OS level accesses the storage control unit 253 to refer to the setting values and make settings.

An external storage cooperation application 220 is a sub-module contained in the OS 210 that controls an application in cooperation with an external storage. An arbitrary number of sub-modules can be contained in the OS.

Upon receipt of a notification of the user's operation from the UI control unit 252, an overall control unit 241 of the external storage cooperation application 220 determines the details of the user's operation. If the user's operation relates to communication with an external storage, the external storage cooperation application 220 performs external communication through the NW control unit 254.

The external storage cooperation application 220 instructs the UI control unit 252 to update the rendering, in response to the result of the communication. Information for communicating with the external storage is acquired by receiving an input from the user or referring to a setting saving unit (not illustrated). If the user's operation relates to scanning or printing, the external storage cooperation application 220 instructs the job control unit 251 to make a request.

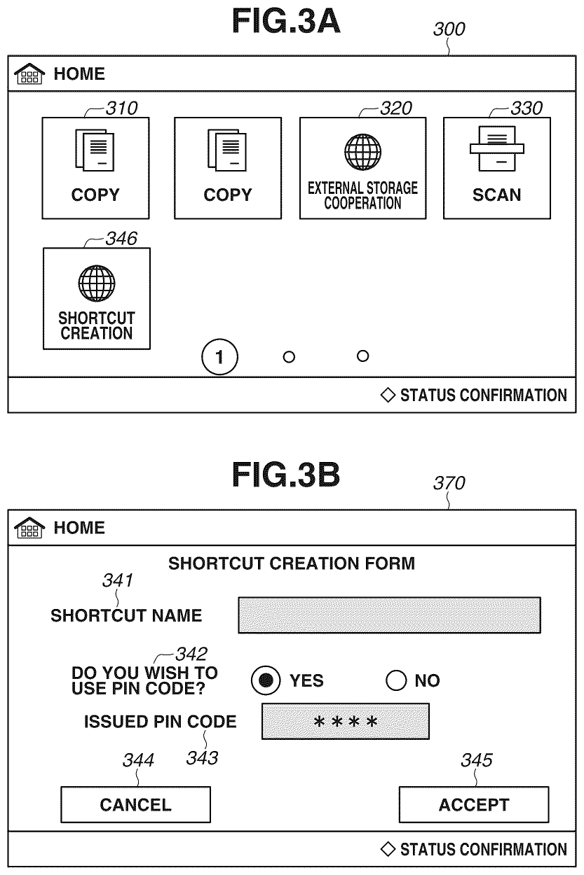

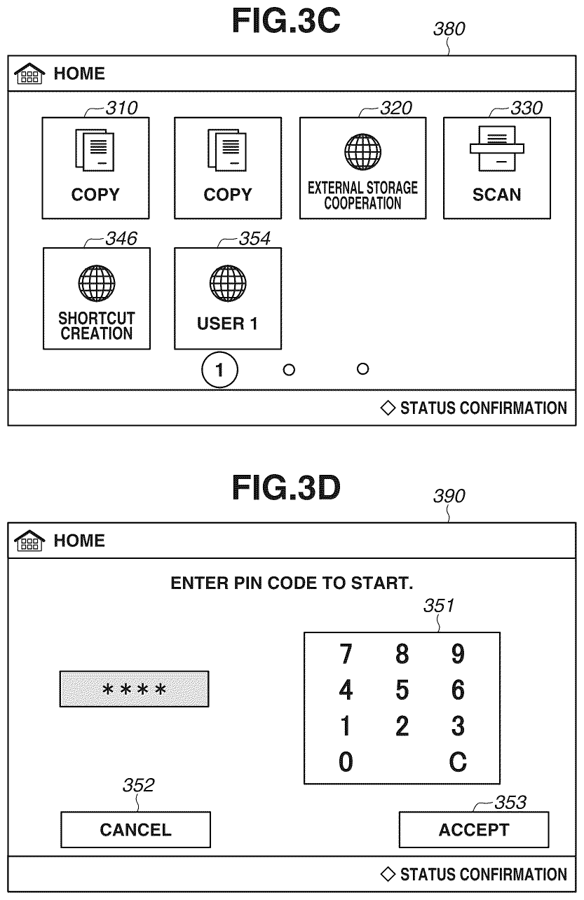

Upon receipt of a startup request from the UI control unit 252, a shortcut creation application 230 causes the operation unit 112 to display a shortcut creation screen 370 as illustrated in FIG. 3B described below. Upon receipt of a notification of the user's operation from the UI control unit 252, a shortcut creation unit 231 performs a creation process of a shortcut button (hereinafter, button) 354 of an external storage cooperation application. If the use of an authentication code for user authentication is selected at the time of creation of the button 354, the shortcut creation unit 231 requests an authentication code generation unit 232 to generate a unique authentication code associated with the shortcut. FIG. 3B illustrates a personal identification number (PIN) code as an example of authentication code, but the present disclosure is not limited to this example For example, the authentication may be fingerprint authentication or ID card authentication.

The authentication code generation unit 232 generates a unique authentication code and saves the authentication code in the storage control unit 253. The authentication code generation unit 232 also saves information on the button name input at the time of creation of the button 354 in the storage control unit 253. The authentication code generation unit 232 saves the input setting information as illustrated in FIG. 3B in the storage control unit 253.

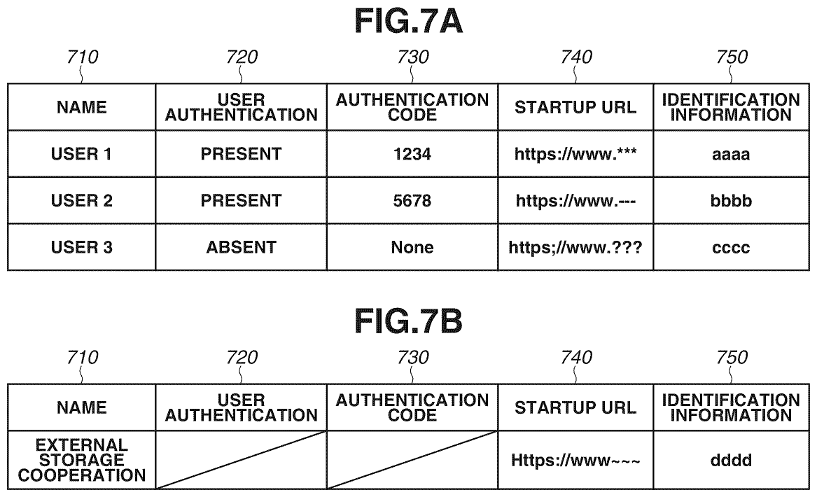

An external storage cooperation application shortcut (hereinafter, application shortcut) 240 illustrated in FIG. 2 is an application that has functions equivalent to those of an external storage cooperation application, which is created by the shortcut creation application 230. Although the term “shortcut” is used, the creation of an application different in the management information about the external storage cooperation application (refer to FIG. 7 described below) is intended here.

The application shortcut 240 is not a merely copy of the external storage cooperation application 220 but includes external storage cooperation destinations and user information saved as illustrated in FIG. 7 described below. If there is a plurality of application shortcuts 240, it is possible to make the external storage contacts and the saved user information different from each other. The number of shortcuts created is arbitrary.

Upon receipt of a notification of the user's operation from the UI control unit 252, the overall control unit 241 of the application shortcut 240 refers to the authentication code collation unit 242. Specifically, the overall control unit 241 determines whether a PIN code is set or a startup URL that is address information on the access destination at the time of startup is set. If a PIN code is set, an authentication screen 390 as illustrated in FIG. 3D is displayed to wait for the user's input.

The application shortcut 240 and the external storage cooperation application 220 each have identification information. Thus, in the case of executing the external storage cooperation application 220, information such as the operation history and settings of the browser 1108 are stored in the image generation system 1100 in association with the identification information indicating the external storage cooperation application 220. Similarly, in the case of executing the application shortcut 240, information such as the operation history and settings of the browser 1108 are stored in the image generation system 1100 in association with the identification information indicating the application shortcut 240. Accordingly, in the case of executing the application shortcut 240, for example, the image generation system 1100 renders web pages in accordance with the identification information indicating the application shortcut 240 and the startup URL information described below. Then, the image formation device 1101 acquires the web contents based on the results of the rendering.

Upon receipt of a notification of the user's operation from the UI control unit 252, the overall control unit 241 requests an authentication code collation unit 242 to collate the input PIN code with the preset PIN code. The authentication code collation unit 242 refers to the setting saving unit (not illustrated) to acquire the PIN code associated with the shortcut. The authentication code collation unit 242 returns the result of collation of the acquired PIN code with the user input PIN code to the overall control unit 241. If the result of the collation is true, the overall control unit 241 provides functions equivalent to those of the external storage cooperation application to the user. If the startup URL (address information for accessing at the time of startup) is set in a field 451, for example, the overall control unit 241 communicates to the specified URL through the NW control unit 254. Specifically, the overall control unit 241 accesses the web contents server 1105 via the image generation system 1100. In response to the result of the communication, the overall control unit 241 requests the UI control unit 252 to update the screen display. If the result of the collation is false, the overall control unit 241 requests the UI control unit 252 to display a message indicating that the input PIN code is not appropriate.

The screens illustrated in FIGS. 3A to 3D are generated by the CPU 101 running the program constituting the UI control unit 252 illustrated in FIG. 2, and are displayed on the operation unit 112.

FIG. 3A is a diagram illustrating an example of a home screen displayed on the image formation device 1101.

FIG. 3A illustrates an example in which five icons are displayed on a home screen 300, but any number of buttons can be displayed. In the present exemplary embodiment, the buttons refer to icons.

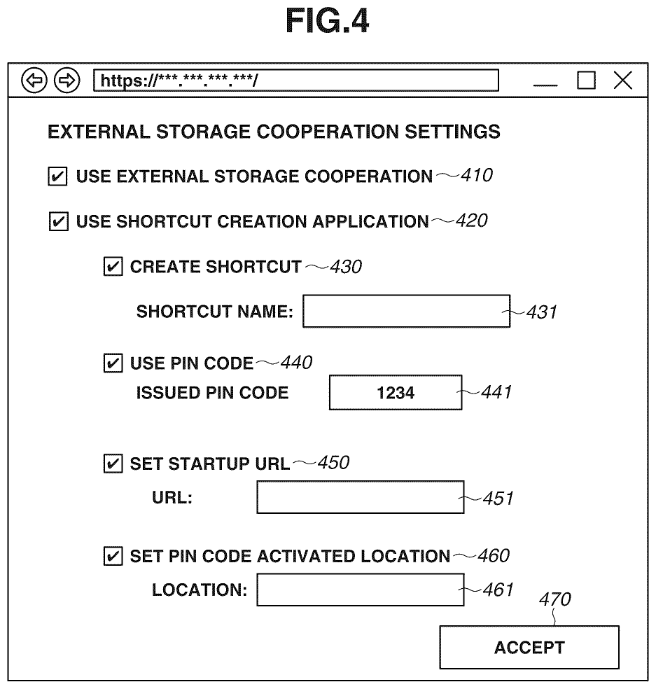

A button 310 is an example of a button related to the copying function. A button 330 is an example of a button related to the scanning function. A button 320 is an example of an external storage cooperation application button. The button 320 is displayed on the home screen if the use of external storage cooperation is checked in a checkbox 410 illustrated in FIG. 4. If any button is selected, the function associated with the button is executed.

FIG. 3B is a diagram illustrating an example of the shortcut creation screen 370 that is displayed on the operation unit 112 when a button 346 is selected. A shortcut name 341 receives an input of a title to be displayed with the shortcut on the home screen. If an accept button 345 is selected without inputting any title, the shortcut creation unit 231 sets a button name.

A radio button 342 provides options of whether a user authentication function is added in the case of creating the shortcut of an external storage cooperation application. If the user selects Yes, a PIN code input field 343 appears and displays a unique PIN code generated by the shortcut creation unit 231. If the user changes the selection from Yes to No, the PIN code displayed in the PIN code input field 343 is discarded. If the user selects Yes again, the authentication code generation unit 232 generates and displays a unique PIN code in the PIN code input field 343. The generated PIN code may be different from the firstly displayed PIN code, but they are both unique PIN codes associated with the shortcut.

If the user selects a cancel button 344, the screen display returns to the home screen 300 illustrated in FIG. 3A. When the cancel button 344 is selected, the information input by the selection of the cancel button 344 is discarded. If the user selects the accept button 345, the shortcut creation unit 231 creates a shortcut (for example, the shortcut 354) based on the input information. Upon completion of the creation, the screen display transitions to a home screen 380 illustrated in FIG. 3C. If the creation has failed, an error message, for example, “The shortcut creation has failed” is displayed. When a specific period of time has elapsed from the start of creation of the shortcut 354, the screen display returns to the home screen 300 illustrated in FIG. 3A.

FIG. 3C is a diagram illustrating an example of the home screen 380 displayed on the image formation device 1101. The home screen 380 additionally includes the button 354, different from the home screen 300 illustrated in FIG. 3A. The button 354 is the shortcut of the external storage cooperation application added by the user. When the user selects the button 354 with the shortcut of the button 354 provided with the user authentication function, the authentication screen 390 illustrated in FIG. 3D is opened at the time of startup of the external storage cooperation application to request the user to input the user authentication information (PIN code). If the shortcut of the button 354 is not provided with the user authentication function, the screen illustrated in FIG. 3D is not opened.

FIG. 3D is a diagram illustrating an example of the authentication screen 390 on which the input of the user authentication information is requested, which is displayed when the button 354 is selected in the case where the user authentication function is provided. When the authentication screen 390 illustrated in FIG. 3D is displayed, the user selects a PIN code input field 351 and inputs the PIN code that was displayed at the time of creation of the shortcut. When the user selects an accept button 353 after the input, the authentication code collation unit 242 collates the input PIN code with the PIN code associated with the selected button 354.

If the result of the collation is true, the user can use the functions associated with the button 354. If the result of the collation is false, a message, for example, “the PIN code is incorrect” is displayed for a specific period of time, and then the authentication screen 390 illustrated in FIG. 3D is displayed. If the user selects a cancel button 352, the screen display returns to the home screen 380 illustrated in FIG. 3C. In that case, the information input by the selection of the cancel button 352 is discarded.

FIG. 4 is a diagram illustrating an example of a settings screen of the external storage cooperation application. If the image formation device 1101 has the server function, the setting screen is displayed also when access is made to a web site at a specific URL via a web browser in the user terminal such as a personal computer (PC) or a smartphone connected to a network.

The user operates the setting screen to set the functions of the external storage cooperation application. In the case of using the external storage cooperation function, the user checks the checkbox 410. When the checkbox 410 is checked, the button 320 is displayed. Further, a checkbox 420 and subsequent checkboxes become editable.

Checking the checkbox 420 allows the user to use the shortcut creation application. When the checkbox 420 is checked, the operation unit 112 displays the button 346 on the home screen. Further, a checkbox 430 and subsequent checkboxes become editable. That is, when the checkbox 420 is checked, the creation of a shortcut is permitted.

Checking the checkbox 430 allows the user to create the shortcut of the external storage cooperation application. In addition, a checkbox 440 and subsequent checkboxes become editable. Although the creation of one shortcut is enabled in this example, the creation of a plurality of shortcuts may be enabled. In a field 431, the input of a title to be displayed together with the shortcut created on the home screen is received. When the user selects an accept button 470 without any input, the shortcut creation unit 231 sets a button name.

Checking the checkbox 440 allows the user to add the user authentication function to the created shortcut. When the checkbox 440 is checked, the authentication code generation unit 232 automatically generates a unique PIN code associated with the shortcut and displays the PIN code in a field 441. When the checkbox 440 is unchecked, the field 441 is updated to a blank space, and the displayed PIN code is discarded. When the user checks the checkbox 440 again, the authentication code generation unit 232 generates a unique PIN code and updates the display. Although the generated PIN code may be different from the firstly displayed PIN code, they are both unique PIN codes associated with the shortcut. Although the PIN code is generated in this example, the user may set the PIN code.

Checking a checkbox 450 and specifying the URL allows the user to specify a URL to be first displayed at the time of shortcut execution. In the field 451, the input of an arbitrary URL is received. When the user selects the decide button 470 without any input, the shortcut creation unit 231 sets a startup URL.

Some image formation applications can acquire installation location information. If the image formation device has such capability of acquiring location information, a checkbox 460 is displayed. If the image formation device does not have such capability, the checkbox 460 is not displayed. Checking the checkbox 460 allows the user to switch between activation and deactivation of the authentication function depending on the location.

In a field 461, an input of arbitrary location information is received. When the accept button 470 is selected without any input, the function of the checkbox 460 is deactivated.

The information set in the checkboxes 410 to 460 is provided to and recorded in the image formation device 1101 via the network I/F 110.

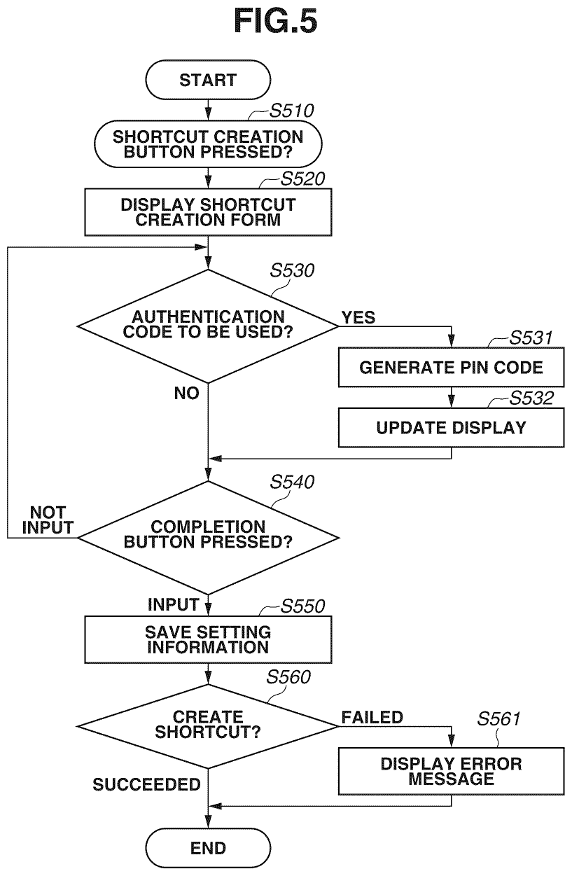

FIG. 5 is a flowchart of a process of creating a shortcut for accessing an external storage, which is performed by an application. The external storage cooperation application 220, the shortcut creation application 230, and the application shortcut 240 are executed by the CPU 101 running programs stored in the storage 104 on the OS.

In step S510, an operation unit I/F 106 detects the selection of the button 346, and the CPU 101 loads the shortcut creation application 230 associated with the button 346 to the RAM 102 and executes the shortcut creation application 230.

In step S520, the shortcut creation unit 231 requests the UI control unit 252 to display a shortcut creation form screen as illustrated in FIG. 3B. Upon completion of the display, the process proceeds to step S530.

In step S530, the shortcut creation unit 231 determines whether to use the authentication code. The shortcut creation unit 231 acquires user input information from the UI control unit 252 in succession. The shortcut creation unit 231 determines the information input by the radio button 342 in the input information. If Yes is selected (YES in step S530), the shortcut creation unit 231 determines that an authentication code is to be used, and the process proceeds to step S531. If No is selected (NO in step S530), the shortcut creation unit 231 determines that an authentication code is not to be used, and the process proceeds to step S540.

In step S531, the shortcut creation unit 231 requests the authentication code generation unit 232 to generate an authentication code. The authentication code generation unit 232 generates a unique PIN code associated with the shortcut, and returns the PIN code to the shortcut creation unit 231. After that, the process proceeds to step S532.

In step S532, the shortcut creation unit 231 requests the UI control unit 252 to display the generated PIN code in the PIN code input field 343 illustrated in FIG. 3B.

After that, the process proceeds to step S540.

In step S540, the shortcut creation unit 231 determines whether the accept button 345 has been selected. If the accept button 345 has been selected (YES in step S540), the process proceeds to step S550. If the accept button 345 has not been selected (NO in step S540), the shortcut creation unit 231 waits for the user's input.

In step S550, the shortcut creation unit 231 processes and saves the user input information. FIG. 7 described below illustrates an example of the processing result saved in the storage control unit 253. If the shortcut name 341 is specified from the user input information, the input is saved as a name 710 (shortcut name) in the storage control unit 253. If the shortcut name 341 is not specified, the shortcut creation unit 231 generates an arbitrary shortcut name such as “User 1” and saves the shortcut name in the storage control unit 253. If the PIN code has been generated in step S531, the shortcut creation unit 231 saves the setting “presence of user authentication” and the generated unique PIN code in the storage control unit 253. After that, the process proceeds to step S560.

In step S560, the shortcut creation unit 231 creates a shortcut based on the information saved in the storage control unit 253 in step S550. The created shortcut is the button 354 illustrated in FIG. 3C, for example. If the shortcut creation has succeeded, the process in the flow is ended. If the shortcut creation has failed, the process proceeds to step S561. In step S561, the shortcut creation unit 231 displays a message, for example, “The shortcut creation has failed” on the UI control unit 252 for a specific period of time. The process of creating a shortcut for accessing an external storage performed by the application is ended.

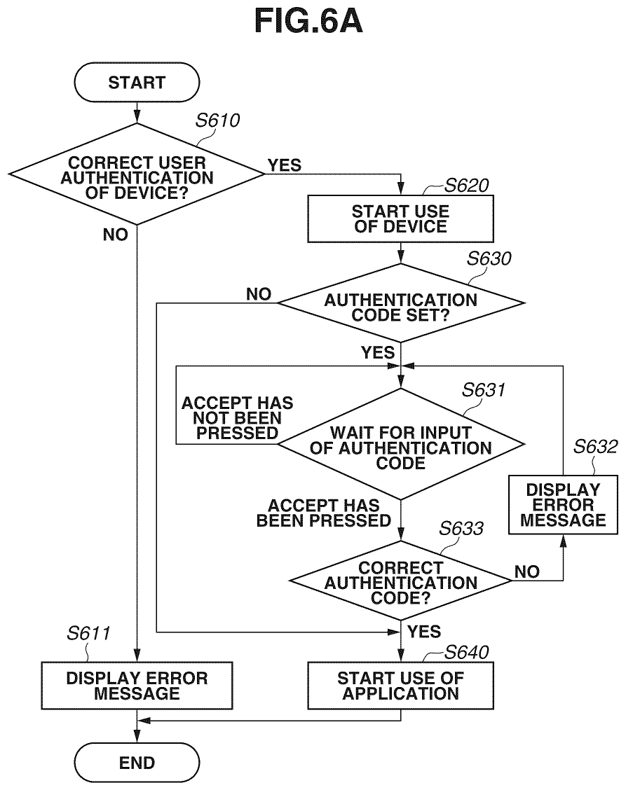

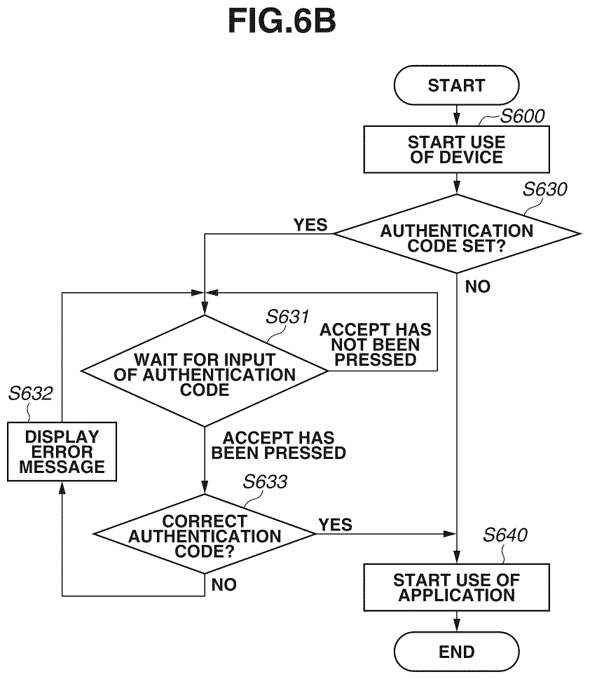

FIG. 6A is a flowchart indicating a procedure of a user authentication process performed by the shortcut for accessing an external storage in the case where the user management function is activated in the image formation device 1101.

In step S610, the OS of the image formation device 1101 executes the user management function of the image formation device 1101. The OS of the image formation device 1101 displays a login request set by the user management function on the operation unit I/F 106. The login request varies depending on the settings in the image formation device 1101 and involves the ID card authentication or an input of the ID set to each user, for example. Any means can be used as long as the user management function is executed. The OS of the image formation device 1101 acquires the user input information from the operation unit I/F 106. The OS of the image formation device 1101 determines whether the user input information matches the user that is a target of user management. If the user matches (YES in step S610), the process proceeds to step S620. If the user does not match, that is, the user is not subject to management (NO in step S610), the process proceeds to step S611.

In step S611, the OS of the image formation device 1101 displays an error message, for example, “The input information is incorrect” on the operation unit I/F 106. In step S620, the OS of the image formation device 1101 displays the home screen 300 as illustrated in FIG. 3A on the operation unit I/F 106.

The OS receives the user's operation and processes the user's request. If the user selects the button 346 for shortcut creation, the process proceeds to step S630.

In step S630, the operation unit I/F 106 detects the selection of the button 346, the CPU 101 loads the application shortcut 240 associated with the button 346 to the RAM 102 and executes the application shortcut 240. The overall control unit 241 refers to the storage control unit 253 to check the presence or absence of setting of user authentication 720. If the user authentication is set (YES in step S630), the process proceeds to step S631.

If the user authentication is not set (NO in step S630), the process proceeds to step S640.

In step S631, the application shortcut 240 requests the UI control unit 252 to display a screen for requesting user authentication as illustrated in FIG. 3D as an example. The application shortcut 240 determines whether the accept button 353 has been selected. If the accept button 353 has been pressed, the process proceeds to step S633. If the accept button 353 has not been pressed, the process returns to step S630.

In step S633, the overall control unit 241 acquires the user input information. Then, the overall control unit 241 requests the authentication code collation unit 242 to collate the input authentication code.

The authentication code collation unit 242 acquires the unique authentication code associated with the button 354 by the storage control unit 253. The authentication code collation unit 242 collates the acquired authentication code with the user input authentication code, and returns the result of the collation to the overall control unit 241. The overall control unit 241 determines the result of the collation. If the authentication codes match each other (YES in step S633), the process proceeds to step S640. If the authentication codes do not match each other (NO in step S633), the process proceeds to step S632.

In step S632, the overall control unit 241 requests the UI control unit 252 to display a message, for example, “The authentication code is incorrect”. If a specific period of time has elapsed after the request or a new user input has been made, the process proceeds to step S631.

In step S640, the use of the application shortcut 240 is started. The overall control unit 241 accesses the web page at the specified startup URL.

Here, the user authentication process performed by the shortcut for accessing an external storage in the case where the image formation device 1101 has the user management function is ended.

FIG. 6B is a flowchart of a user authentication process that is performed by a shortcut for accessing an external storage in the case where the image formation device 1101 does not have the user authentication function. In step S600, the OS of the image formation device 1101 displays the home screen 300 as illustrated in FIG. 3A on the operation unit I/F 106. The OS receives the user's operation and processes the user's request. If the user selects the external storage cooperation application, the process proceeds to step S630.

In step S630, the operation unit I/F 106 detects the selection of the button 354, and the CPU 101 loads the application shortcut 240 associated with the button 354 to the RAM 102 and executes the application shortcut 240. The overall control unit 241 refers to the storage control unit 253 to check the presence or absence of setting of the user authentication 720. If the user authentication is set (YES in step S630), the process proceeds to step S631. If the user authentication is not set (NO in step S630), the process proceeds to step S640.

In step S631, the application shortcut 240 requests the UI control unit 252 to display the screen 390 for requesting user authentication as illustrated in FIG. 3D as an example, and waits for an input of authentication information. The application shortcut 240 determines whether the accept button 353 has been selected. If the accept button 353 has been pressed, the process proceeds to step S633. If the accept button 353 has not been pressed, the application shortcut 240 waits for user input.

In step S633, the overall control unit 241 acquires the user input information. Then, the overall control unit 241 requests the authentication code collation unit 242 to collate the input authentication code. The authentication code collation unit 242 acquires the unique authentication code associated with the application shortcut 240 by the storage control unit 253. The authentication code collation unit 242 collates the acquired authentication code with the user input authentication code, and returns the result of the collation to the overall control unit 241. The overall control unit 241 determines the result of the collation. If the authentication codes match each other (YES in step S633), the process proceeds to step S640. If the authentication codes do not match each other (NO in step S633), the process proceeds to step S632.

In step S632, the overall control unit 241 requests the UI control unit 252 to display a message, for example, “The authentication code is incorrect”. If a specific period of time has elapsed after the request or a new user input has been made, the process proceeds to step S631.

In step S640, the use of the application shortcut 240 having functions equivalent to those of the external storage cooperation application is started. The overall control unit 241 accesses the web page at the specified startup URL.

The user management process performed by the shortcut for accessing the external storage in the case where the image formation device 1101 does not have the user management function is ended here.

FIG. 7A is a diagram illustrating an example of management information on shortcuts for accessing an external storage saved in the storage control unit 253. Although FIG. 7A illustrates three pieces of shortcut setting information, an any number of shortcuts is used.

A name 710 indicates setting information indicating a display name to be displayed together with an icon on the home screen as illustrated in FIGS. 3A and 3C. As illustrated in the shortcut name 341 in FIG. 3B or the checkbox 430 in FIG. 4, the user can set any character string. If there is no specification by the user, a default character string is specified.

A user authentication 720 indicates setting information on whether to add the user authentication function to the shortcut. The user can select whether to add the user authentication function as illustrated in the radio button 342 and the checkbox 440 at the time of shortcut creation. If the user selects adding the authentication function, “Present” is written into the user authentication 720, for example. If the user selects not adding the user authentication function, “Absent” is written into the user authentication 720, for example.

Identification information 750 is identification information indicating each shortcut. The identification information 750 is used to, in communicating with the image generation system 1100 and acquiring information from the browser 1108 at the time of execution of a shortcut, acquire history information and setting information managed for each shortcut.

An authentication code 730 is information indicating a unique authentication code associated with a shortcut. User authentication 720 indicates the presence or absence of user authentication setting, and information is set if the user authentication is present.

The authentication code 730 indicates a four-digit number as an example of authentication code, but an any number of digits is used. The authentication code 730 may be any alternative such as a character string that constitutes a unique authentication code associated with a shortcut, instead of a number. The authentication code 730 can expire in a specific period of time, and resetting of the authentication code 730 can be prompted. To perform resetting, for example, during use of the application shortcut 240, a message “Reset the authentication code” is popped up on the operation unit I/F 106 and a new authentication code is displayed in the PIN code input field 343 illustrated in FIG. 3B. Alternatively, a new authentication code may be displayed in the field 441 on a setting web page as illustrated in FIG. 4.

A startup URL 740 is setting information for specifying the URL of the web page that is first displayed at the time of startup of the shortcut of the external storage cooperation application. The user can specify an any URL as illustrated in the checkbox 450 in FIG. 4. If there is no specification by the user, a default URL is specified.

FIG. 7B illustrates an example of management information on the external storage cooperation application 220. The external storage cooperation application 220 has the startup URL and the name as default values, does not have the setting of user authentication, and does not have an authentication code.

As above, the shortcut setting information illustrated in FIG. 7 can be edited even after shortcut creation on the web page as illustrated in FIG. 4. The authentication code 730 cannot be edited by the user. However, if the setting of the user authentication 720 is changed from “Absent” to “Present”, the unique authentication code generated by the authentication code generation unit 232 is saved. When the resetting is performed, a new authentication code associated with the shortcut is also saved.

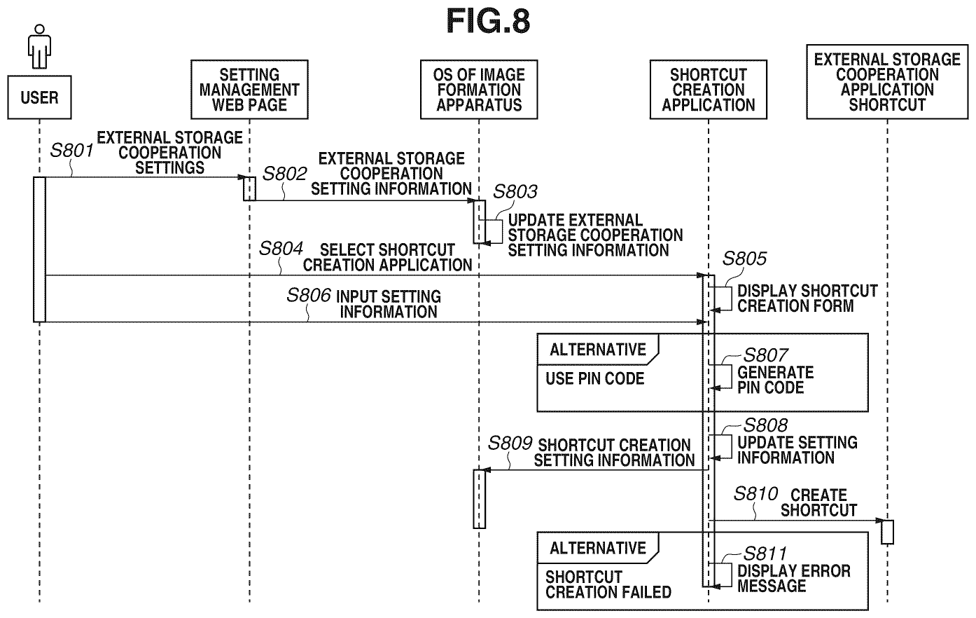

FIG. 8 illustrates a sequence of operations for creating a shortcut for accessing an external storage.

In step S801, the user accesses a setting web page as illustrated in FIG. 4 to set the items. If the image formation device 1101 has the server function, the setting screen is displayed by accessing a web page at a specific URL via a web browser in a user terminal such as a PC or a smartphone connected via a network. When the user selects the accept button 470, the process proceeds to step S802.

In step S802, the setting information input to the setting screen in step S801 is notified to the OS 210 of the image formation device 1101 via the network I/F 110. In step S803, upon receipt of the notification, the OS 210 of the image formation device 1101 writes the setting information to the storage 104. In step S804, the user selects the button 346 on the home screen illustrated in FIG. 3A. The operation unit I/F 106 detects the selection of the button 346, and the CPU 101 loads the shortcut creation application 230 associated with the button 346 to the RAM 102, and executes the shortcut creation application 230.

In step S805, the shortcut creation unit 231 requests the UI control unit 252 to display the shortcut creation screen 370 as illustrated in FIG. 3B. In step S806, the user inputs the shortcut creation information. The shortcut creation unit 231 acquires the user input information from the UI control unit 252 in succession. In the input information, if the information input by the radio button 342 indicates Yes, the process proceeds to step S807. If the information input by the radio button 342 indicates No, the shortcut creation unit 231 continues to acquire the user input information in succession. If the user selects the accept button 345, the process proceeds to step S808.

In step S807, the shortcut creation unit 231 requests the authentication code generation unit 232 to generate an authentication code. The authentication code generation unit 232 generates a unique authentication code associated with the shortcut, and returns the authentication code to the shortcut creation unit 231. The shortcut creation unit 231 requests the UI control unit 252 to display the generated authentication code. The shortcut creation unit 231 continues to acquire the user input information in succession. When the user selects the accept button 345, the process proceeds to step S808.

In step S808, the shortcut creation unit 231 acquires the user input information from the US control unit 252, and if there is a lack of information, the shortcut creation unit 231 automatically generates the information. For example, if there is no input to the shortcut name 341, the shortcut creation unit 231 generates and sets the name such as User 1. In step S809, the shortcut creation unit 231 saves the generated shortcut information as illustrated in FIG. 7 in the storage 104. In step S810, the shortcut creation unit 231 creates the shortcut based on the shortcut creation information. If the shortcut creation has succeeded, the sequence is ended. If the shortcut creation has failed, the process proceeds to step S811. In step S811, the shortcut creation unit 231 requests the UI control unit 252 to display an error message, for example, “The shortcut creation has failed”.

The sequence of operations of creating a shortcut for accessing an external storage is ended here.

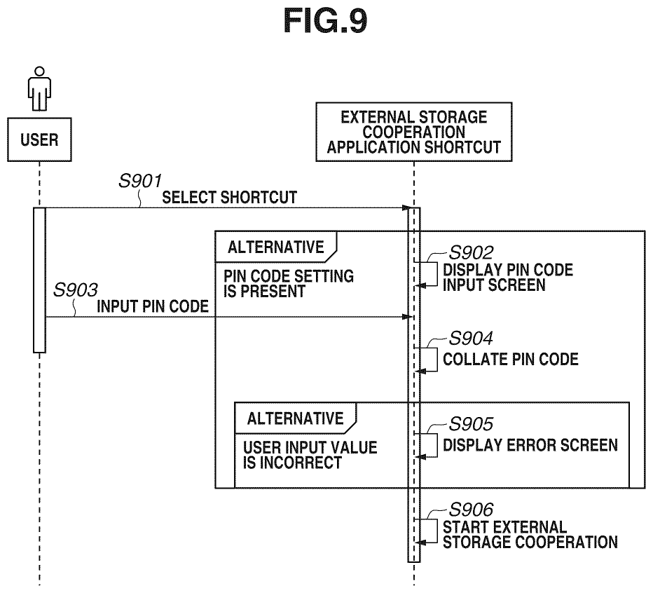

FIG. 9 is a sequence of a process of executing a shortcut for accessing an external storage. In step S901, the user selects the button 354 illustrated in FIG. 3C. The operation unit I/F 106 detects the selection of the button 354, and the CPU 101 loads the application shortcut 240 associated with the button 354 and executes the application shortcut 240. The overall control unit 241 refers to the storage control unit 253 to determine the presence or absence of setting of the user authentication 720.

If the user authentication is set, the process proceeds to step S902. If the user authentication is not set, the process proceeds to step S906.

In step S902, the overall control unit 241 requests the UI control unit 252 to display the authentication screen 390 as illustrated in FIG. 3D. After that, the process proceeds to step S903.

In step S903, the user inputs the PIN code in accordance with the screen display illustrated in FIG. 3D.

Upon completion of the input, the user selects the accept button 353. The operation unit I/F 106 detects the selection of the button 353 and make a notification of the detected selection of the button 353 to the overall control unit 241 through the UI control unit 252, and the process proceeds to step S904. In step S904, the overall control unit 241 requests the authentication code collation unit 242 to collate the input PIN code. The authentication code collation unit 242 refers to the storage control unit 253 to acquire the unique PIN code associated with the shortcut. The authentication code collation unit 242 collates the acquired authentication code with the input authentication code, and returns the result of the collation. The overall control unit 241 determines the returned result, and if the input authentication code matches, the process proceeds to step S906. If the input authentication code does not match, the process proceeds to step S905.

In step S905, since the user input authentication code is incorrect, the overall control unit 241 requests the UI control unit 252 to display a message, for example, “The authentication code is incorrect”. After a lapse of a specific period of time after the display of the message, the process proceeds again to step S902. In step S906, the external storage cooperation application is started. If the startup URL 740 associated with the shortcut is set, the web page specified at the startup URL is displayed.

This process of executing a shortcut for accessing an external storage is ended here.

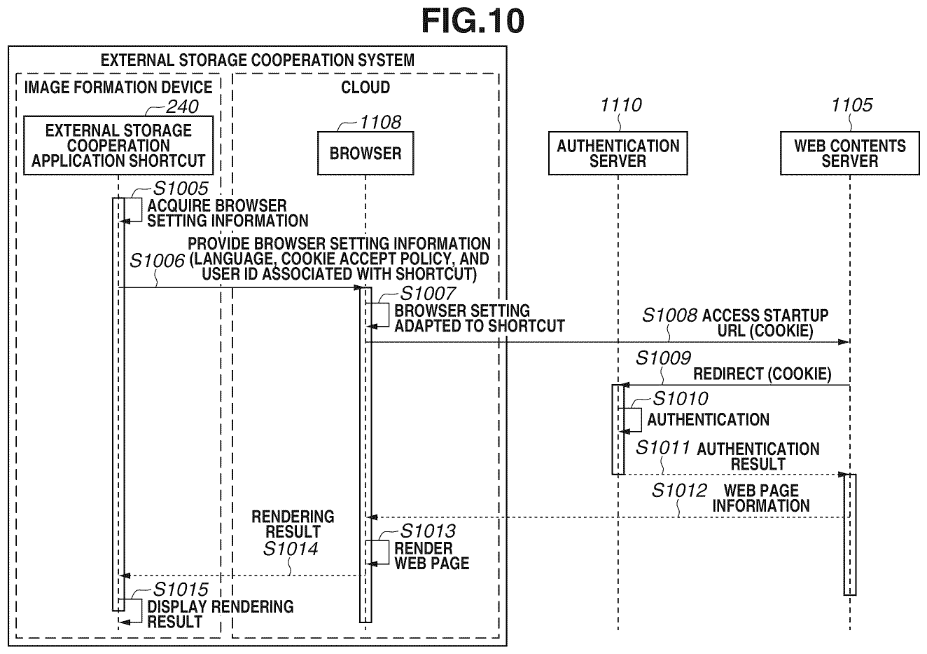

FIG. 10 illustrates a sequence of a process after startup of the external storage cooperation application. If the user authentication of the shortcut has succeeded, the use of the external storage cooperation application is started as in step S640 and step S906. FIG. 10 illustrates the details of the processing in step S640 and step S906. First, a configuration illustrated in FIG. 10 will be described.

As stated above, the application shortcut 240 refers to an application that is executed by the CPU 101 in the image formation device 1101. As described above, the authentication server 1110 is an example of an authentication site such as OAuth. In general, the web contents server 1105 performs user authentication using a third party's authentication site.

The browser 1108 is a browser that is placed in a cloud and communicates with the image formation device 1101. If the browser cannot be placed in the image formation device 1101, the browser may be separately placed in a cloud. In this configuration, the image formation device 1101 acts as a user interface and provides the user input information to the browser in the cloud using a specific application program interface (API) (identification information 750). The browser in the cloud interprets the user input information and performs a browser operation. If the browser performs rendering as a result of the browser operation, the browser notifies the image formation device 1101 of the rendering result. The image formation device 1101 receives the notification of the rendering result, and displays the rendering result on the operation unit 112. In this manner, even if the image formation device 1101 has no browser, the image formation device 1101 uses a browser in the cloud to perform equivalent operations. Personal information such as cookies on the user who uses a browser may be saved in the storage in the cloud. Thus, the user who has activated a setting of accepting cookies during the use of the browser can use single sign on (SSO). The browser 1108 identifies personal information such as cookies in association with the user ID notified by the image formation device 1101.

The web contents server 1105 is a service for saving photographs and documents in a storage in a cloud, for example.

The steps in FIG. 10 will be described. In step S1005, if the user authentication illustrated in FIG. 9 has succeeded, the application shortcut 240 acquires information associated with the shortcut as illustrated in FIG. 7 from the storage control unit 253. The information includes, in addition to the startup URL, the browser language setting, the cookie accept policy, the user ID associated with the shortcut, and others.

In step S1006, the application shortcut 240 provides the information acquired in step S1005 together with a startup request to the browser 1108. This information includes the startup URL acquired in step S1005, the browser language setting, the cookie accept policy, the user ID associated with the shortcut, and others. In step S1007, upon receipt of the startup request from the image formation device 1101, the browser 1108 starts to operate and makes initial settings based on the information provided by the application shortcut 240. Specifically, the browser 1108 makes a language setting and a cookie accept setting. In addition, the browser 1108 refers to the storage in the cloud. If the cookie information associated with the user ID is saved, the browser 1108 sets the cookie information to the cookie header.

The cookie information in the case where the authentication of the web contents server 1105 has passed includes a token that has been authenticated in an authentication site. Personal authentication of an external storage service is performed at the authentication site based on the token. Thus, when the application shortcut 240 is accessible, it is possible to login to the web contents server 1105. Thus, considering privacy, this involves more reliable identification of the user accessing the application shortcut 240.

In step S1008, the browser 1108 accesses the startup URL and requests the web contents server 1105 to acquire the web pages. At this time, the cookie information has been already set to the header in step S1007. In step S1009, the web contents server 1105 performs user authentication in response to the request for acquisition. The web contents server 1105 redirects the web pages together with the cookie information to the authentication server 1110.

In step S1010, the authentication server 1110 performs user authentication based on the coolie information. In step S1011, the authentication server 1110 returns the result of the authentication in step S1010 to the web contents server 1105.

In step S1012, if the authentication result is true, the web contents server 1105 returns the normal web page information to the browser 1108. If the authentication result is false, the web contents server 1105 returns the information indicating the failure of the authentication.

In step S1013, the browser 1108 performs rendering based on the web page information returned in step S1012. In step S1014, the browser 1108 returns the rendering result to the application shortcut 240. In step S1015, the application shortcut 240 displays the rendering result received in step S1014 on the operation unit 112.

The procedure of a process after the startup of the external storage cooperation application is ended here.

### Other Exemplary Embodiments

As above, various examples and exemplary embodiments of the present disclosure have been described. However, the gist and scope of the present disclosure are not limited by the specific description herein.

The present disclosure may be implemented by supplying a program for carrying out one or more functions of the above-described exemplary embodiments to a system or an apparatus via a network or a storage medium, and reading and running the program by one or more processors in the system or the apparatus. The present disclosure can also be implemented with a circuit for carrying out the one or more functions (for example, an application specific integrated circuit (ASIC)).

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-105933, filed Jun. 28, 2023, which is hereby incorporated by reference herein in its entirety.

What is claimed is:

1. A communication system includes an image generation server configured to perform rendering of web contents and an information processing apparatus configured to execute a first application to be managed with first management information and acquire the web contents related to a result of the rendering, the communication system comprising:
one or more controllers including one or more processors and one or more memories, the one or more controllers being configured to:
create a second application to be managed with second management information different from the first management information and acquire web contents based on the result of the rendering; and
set authentication information to the second application.

2. The communication system according to claim 1,
wherein the information processing apparatus includes a display unit on which a home screen is displayable; and
wherein the first application and the second application are displayed on the home screen in a selectable manner.

3. The communication system according to claim 2,
wherein the information processing apparatus is an image formation apparatus that forms an image on a sheet, and
wherein the home screen displays an icon, in a selectable manner, for instructing execution of a function of forming an image on a sheet by the image formation apparatus.

4. The communication system according to claim 2, further comprising a reading apparatus configured to read an image from a document,
wherein the home screen displays an icon, in a selectable manner, for instructing execution of a function of reading an image from a document by the reading apparatus.

5. The communication system according to claim 1, wherein the authentication information is automatically set to the second application.

6. The communication system according to claim 1, wherein the one or more controllers are configured to:
receive an input of the authentication information by receiving an execution instruction of the second application to which the authentication information is set;
check whether the received authentication information is the set authentication information; and
in a case where the received authentication information and the set authentication information are identical, access the image generation server based on the second management information.

7. The communication system according to claim 6, wherein the one or more controllers are configured to, in a case where the received authentication information and the set authentication information are not identical, receive authentication information again.

8. The communication system according to claim 6, wherein the one or more controllers are further configured to:
authenticate a user; and
in a case where setting of authenticating the user is activated, receive the authentication information after user authentication has succeeded.

9. The communication system according to claim 1,
wherein the first management information is first address information for accessing the web contents or identification information indicating the first application, and
wherein the second management information is second address information for accessing web contents different from the web contents or identification information indicating the second application.

10. The communication system according to claim 1, wherein the one or more controllers are further configured to set whether to permit creation of an application, other than the first application, for acquiring the web contents based on the result of the rendering.

11. The communication system according to claim 1, wherein the authentication information is a code.

12. An information processing apparatus configured to communicate with an image generation server configured to perform rendering of web contents and execute a first application to be managed with first management information and acquire the web contents based on a result of the rendering, the information processing apparatus comprising:
one or more controllers including one or more processors and one or more memories, the one or more controllers being configured to:
create a second application to be managed with second management information different from the first management information and acquire the web contents based on the result of the rendering; and
set authentication information to the second application.
